(19) United States
(12) Patent Application Publication
(10) Pub. No.: US 2021/0239145 A1
(43) Pub. Date: Aug. 5, 2021

(54) COVERED OPENING FASTENER

(71) Applicants: Craig Richards Erekson, Winder, GA (US); Levi Webb Erekson, Winder, GA (US)

(72) Inventors: Craig Richards Erekson, Winder, GA (US); Levi Webb Erekson, Winder, GA (US)

(21) Appl. No.: 17/138,752

(22) Filed: Dec. 30, 2020

Related U.S. Application Data
(60) Provisional application No. 62/968,145, filed on Jan. 30, 2020.

(51) Int. Cl. F16B 15/00; E04F 21/18

(52) U.S. Cl. CPC F16B 15/0023; F16B 2015/0076; E04F 21/1855

(57) ABSTRACT

Implementations of a covered opening fastener are provided. In some implementations, the covered opening fastener comprises a shelf and a shaft or one or more spikes.

In some implementations, a method for using the covered opening fastener comprises attaching the covered opening fastener to an edge portion of a first object, such as a first roofing part, and driving the covered opening fastener into and/or through a second object, such as a second roofing part, to thereby attach the first object and the second object together by the covered opening fastener without forming an opening through the first object.

### CROSS REFERENCE TO RELATED APPLICATION

This application claims the benefit of U.S. Patent Application Ser. No. 62/968,145, which was filed on Jan. 30, 2020 and is incorporated herein by reference in its entirety.

### TECHNICAL FIELD

This disclosure relates to implementations of a covered opening fastener.

### BACKGROUND

FIG. 1 illustrates an example existing fastener in the form of a nail. As shown in FIG. 1, a typical nail comprises a head, a shank, and a point. As shown in FIG. 2A, nails are used in roofing to connect different parts of a roof together, such as roof flashing to roof shingles. However, exposed nails are problematic in roofing because eventually the opening created by the nail will leak causing water to enter the opening. Furthermore, there does not exist a fastener for nailing a first object, such as a first roofing part, to a second object, such as a second roofing part, without creating an opening in the first object using the nail.

### BRIEF DESCRIPTION OF THE DRAWINGS

FIG. 1 illustrates an example existing nail fastener.

FIG. 2A illustrates an example use of the existing nail fastener.

FIGS. 2B and 2C illustrates other example uses of the existing nail fastener.

FIG. 3 illustrates an implementation of an example covered opening fastener according to the present disclosure.

FIGS. 4-7 illustrate example use of the covered opening fastener according to the present disclosure.

FIGS. 8-11 illustrate alternate implementations of the covered opening fastener of FIG. 3.

FIGS. 12-17 illustrate another implementation of an example covered opening fastener according to the present disclosure.

FIGS. 18 and 19 illustrate additional views of the covered opening fastener of FIGS. 12-17.

FIGS. 20-24 illustrate another example use of the covered opening fastener according to the present disclosure.

### DETAILED DESCRIPTION

Implementations of a covered opening fastener are provided. In some implementations, the covered opening fastener comprises a shelf and a shaft or one or more spikes.

In some implementations, the covered opening fastener is configured to fasten a first object, such as a first roofing part, to a second object, such as a second roofing part, without creating an opening in the first object.

In some implementations, the covered opening fastener is configured to not expose the covered opening fastener driven into and/or through the second object.

In some implementations, the covered opening fastener is configured to prevent moisture from leaking through the first object and the opening formed by the covered opening fastener in the second object.

In some implementations, the covered opening fastener is further configured to attach or otherwise secure a first object and a second object together and to a third object, such as a first roofing part, a second roofing part, and a roof frame respectively.

In some implementations, the covered opening fastener may be further configured to use as a roofing flashing clip.

In some implementations, a method of using the covered opening fastener comprises attaching the covered opening fastener to an edge portion of a first object, such as a first roofing part, and driving the covered opening fastener into and/or through a second object, such as a second roofing part, to thereby attach the first object and the second object together by the covered opening fastener without forming an opening through the first object.

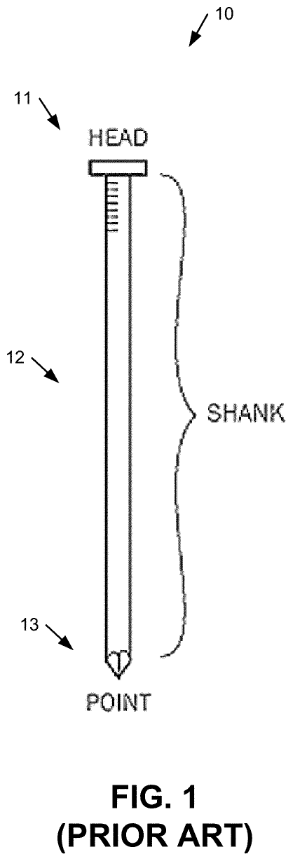

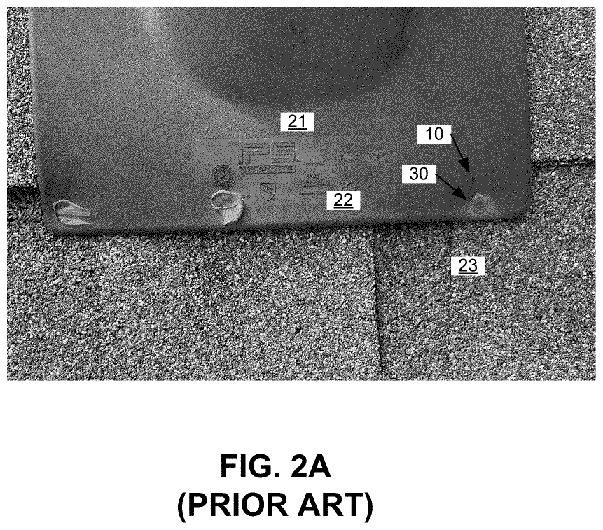

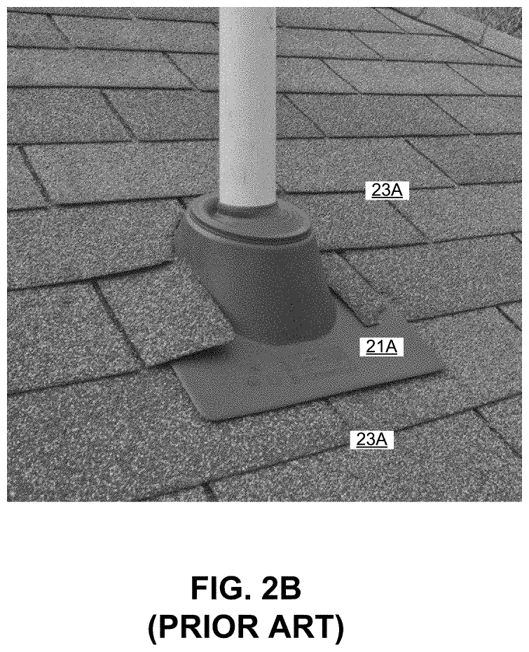

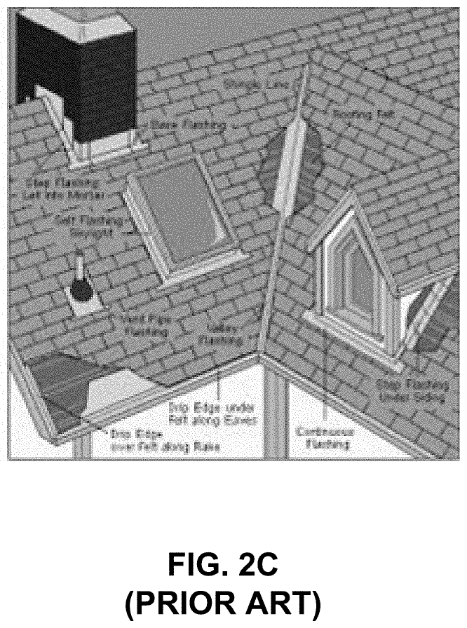

FIG. 1 illustrates an example existing fastener in the form of a nail 10. As shown in FIG. 1, a typical nail 10 comprises a head 11, a shank 12, and a point 13. FIG. 2A illustrates an example use of the existing nail fastener 10. As shown in FIG. 2A, nails 10 are used in roofing to connect different parts 21, 23 of a roof (such as roof flashing and roof shingles) together by driving the nails 10 through an edge 22 or other portion of the parts 21, 23. However, exposed nails 10 are problematic in roofing because eventually the opening 30 created by the nail 10 will leak allowing damage-causing moisture to enter through the opening 30.

FIGS. 2B and 2C illustrates other example uses of the existing nail fastener 10. For example, FIG. 2B illustrates an example roof vent pipe flashing 21A and example roof shingles or tiles 23A.

FIG. 2C illustrates other various examples of roof flashing, roof shingles, and other roof components that are attached together using the existing nail fastener 10. As shown in FIG. 2C, roof flashing has various forms and is attached to roof shingles or other roof components to repel water away from roof components or features, such as vents, chimneys, windows, skylights, and joints. Roof flashing is usually composed of one or more various materials, such as metal (e.g., galvanized steel, aluminum, or copper), rubber, plastic, or felt.

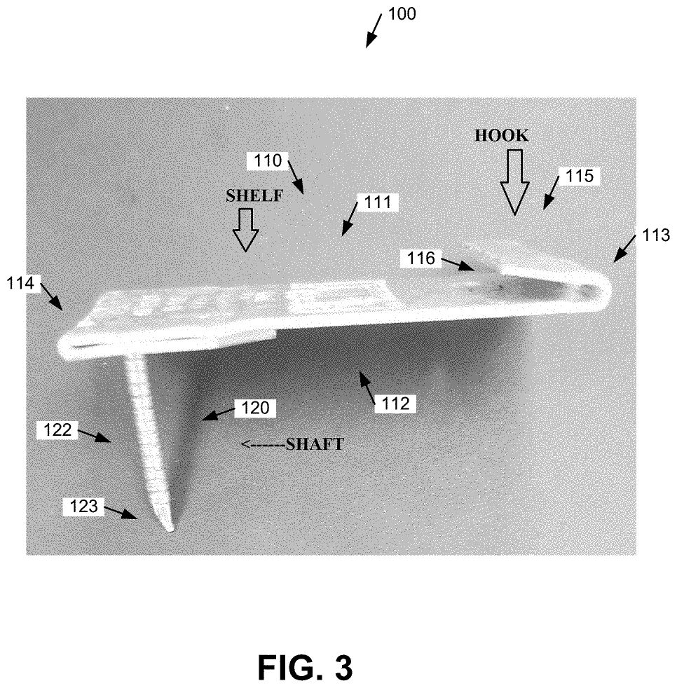

FIG. 3 illustrates an implementation of an example covered opening fastener 100 according to the present disclosure. As shown in FIG. 3, in some implementations, the covered opening fastener 100 comprises a shelf 110 and a shaft 120.

As shown in FIG. 3, in some implementations, the shelf 110 comprises a top surface 111, a bottom surface 112, a first side 113, a second side 114, a hook 115, a channel 116, a third side 117, and a fourth side 118. In some implementations, the shelf 110 may comprise any other suitable features.

As shown in FIG. 3, in some implementations, the bottom surface 112 is opposite the top surface 111. In some implementations, the second side 114 is opposite the first side 113. In some implementations, the third side 117 is opposite the fourth side 118.

In some implementations, the shelf 110 is generally planar panel or rectangular prism shaped. For example, in some implementations, the top surface 111 and the bottom surface 112 extend lengthwise between the first side 113 and the second side 114 and extend widthwise between the third side 117 and the fourth side 118.

In some implementations, the top surface 111 and the bottom surface 112 are generally rectangular shaped. In some implementations, the shelf 110, including the surfaces 111, 112, and the sides 113, 114, 117, 118, may be any other suitable shape.

As shown in FIG. 3, in some implementations, the hook 115 extends from the first side 113 of the shelf 110. In some implementations, the hook 115 extends along the first side 113 of the shelf 110 or along a portion of the first side 113 of the shelf 110. In some implementations, the hook 115 extends upward from the shelf 110. In some implementations, the hook 115 thereby forms the channel 116 above the top surface 111 of the shelf 110.

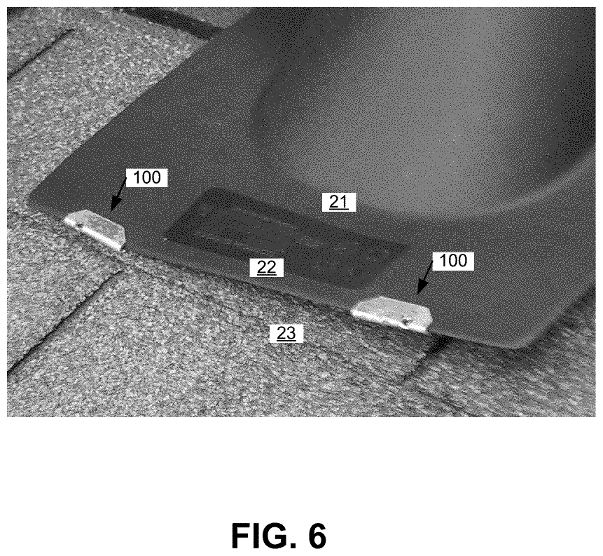

In some implementations, the hook 115 is configured to receive an edge portion of a first object. In some implementations, the hook 115 is configured to hold or otherwise secure thereto the received edge portion of the first object. For example, as shown in FIG. 6, in some implementations, the hook 115 is configured to receive and hold an edge portion 22 of a first part 21 of a roof, such as roof flashing described above for FIGS. 2A-2C.

In this way, in some implementations, the hook 115 is configured to attach or otherwise secure a first object, such as a first roofing part 21, and the covered opening fastener 100 together. Furthermore, in this way, in some implementations, the hook 115 is configured to attach or otherwise secure the first object and the covered opening fastener 100 together without forming an opening through the first object, like the opening 30 through the first roofing part 21 as described above for FIG. 2A.

In some implementations, the shaft 120 may be similar to a nail fastener, such as the nail fastener 10 described above for FIG. 1. For example, as shown in FIG. 3, in some implementations, the shaft 120 may comprise a shank 122 and a point 123.

As shown in FIG. 3, in some implementations, the shaft 120 extends from the bottom surface 112 of the shelf 110. In some implementations, the shaft 120 extends adjacent to the second side 114 of the shelf 110 opposite the hook 115.

In some implementations, the shaft 120 extends perpendicular or generally perpendicular to the bottom surface 112 of the shelf 110.

In some implementations, the covered opening fastener 100 may further comprise a piece of adhesive tape. In some implementations, the adhesive tape may be attached to the bottom surface 112 or to any other suitable position of the covered opening fastener 100. For example, in some implementations, the adhesive tape may be attached to the bottom surface 112 adjacent to the shaft 120.

In some implementations, the covered opening fastener 100 may comprise the piece of adhesive tape and not comprise the shaft 120. For example, in some implementations, the adhesive tape may replace the attachment features provided by the shaft 120.

Alternately, in some implementations, the covered opening fastener 100 may comprise the adhesive tape and the shaft 120. For example, in some implementations, the adhesive tape may supplement the attachment features provided by the shaft 120.

In some implementations, the adhesive tape may be any suitable adhesive tape. For example, in some implementations, the adhesive tape may be a butyl tape. In some implementations, the adhesive tape may be double-sided (e.g., having adhesive on both surface sides of the tape).

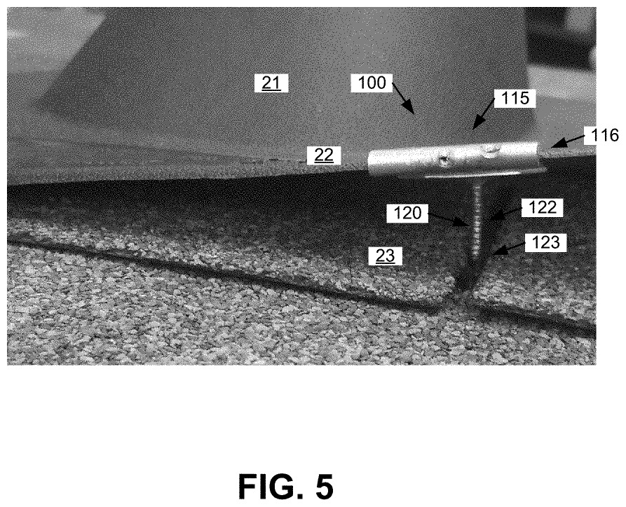

In some implementations, the shaft 120 is configured to be driven into and/or through a second object. For example, as shown in FIG. 5, in some implementations, the shaft 120 is configured to be driven into and/or through a second part 23 of a roof, such as roof shingles described above for FIG. 2A-2C. In this way, in some implementations, the shaft 120 is configured to attach or otherwise secure a second object, such as a second roofing part 23, and the covered opening fastener 100 together.

In some implementations, the shaft 120 is further configured to be driven into and/or through a third object to thereby attach or otherwise secure the first object, the second object, and the third object together by the covered opening fastener 100. For example, in some implementations, the shaft 120 is configured to be driven into and/or through a roof frame or other suitable structure (not shown) to thereby attach or otherwise secure the covered opening fastener 100, the second roofing part 23, and the roof frame together.

In some implementations, the shaft 120 is configured to form an opening in or through the second object when the shaft is driven into and/or through the second object, like the opening 30 through the second roofing part 23 as described above for FIG. 2A. In some implementations, the shelf 110 is configured to cover the opening formed by the shaft 120 in or through the second object.

In some implementations, the covered opening fastener 100 is configured to receive and hold an edge portion of a first object, such as an edge portion 22 of a first roofing part 21, such as roof flashing described above for FIGS. 2A-2C.

In some implementations, the covered opening fastener 100 is configured to attach or otherwise secure the first object and the covered opening fastener 100 together without forming an opening through the first object, like the opening 30 through the first roofing part 21, such as roof flashing described above for FIGS. 2A-2C.

In some implementations, the covered opening fastener 100 is configured to be driven into and/or through a second object, such as a second roofing part 23, to attach or otherwise secure the second object and the covered opening fastener 100 together.

In some implementations, the covered opening fastener 100 is configured to cover an opening formed in or through the second object by the covered opening fastener 100 when the covered opening fastener 100 is driven into and/or through the second object.

In this way, in some implementations, the covered opening fastener 100 is configured to fasten a first object, such as the first roofing part 21, to a second object, such as the second roofing part 23, without creating an opening in the first object.

Furthermore, in this way, in some implementations, the covered opening fastener 100 is configured to not expose the covered opening fastener 100 driven into and/or through the second object.

Moreover, in this way, in some implementations, the covered opening fastener 100 is configured to prevent moisture from leaking through the first object and the opening formed by the covered opening fastener 100 in the second object.

In some implementations, the covered opening fastener 100 is further configured to attach or otherwise secure a first object and a second object together and to a third object. For example, in some implementations, the covered opening fastener 100 is configured to be driven into and/or through a roof frame or other suitable structure to thereby attach or otherwise secure the first roofing part 21, the second roofing part 23, and the roof frame together by the covered opening fastener 100.

In some implementations, the covered opening fastener 100 may be further configured to use as a roofing flashing clip, such as by the features described above and further below.

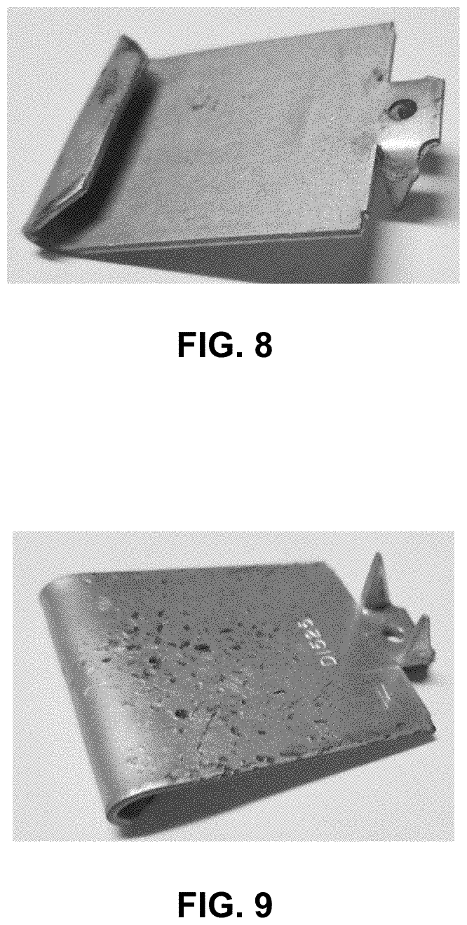

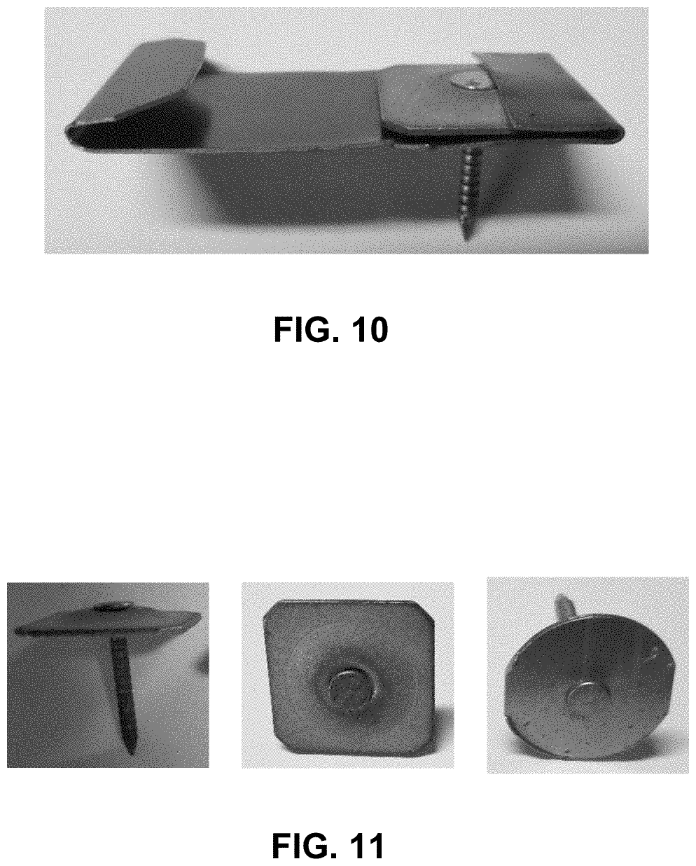

FIGS. 8-11 illustrate alternate implementations of the covered opening fastener 100 of FIG. 3 described herein. For example, FIGS. 8 and 9 illustrate alternate implementations of the covered opening fastener 100 in which the shaft 120 alternately comprises one or more cleat-like extensions. FIGS. 10 and 11 illustrate an alternate implementation of the covered opening fastener 100 (e.g., shown in FIG. 10) in which the shaft 120 (e.g., shown in FIGS. 10 and 11) alternately comprises a nail-like extension having a wider head in various shapes (e.g., square, circular, etc.). Other features/aspects of these alternate implementations will be recognized and understood by one of ordinary skill in the art in light of the present disclosure.

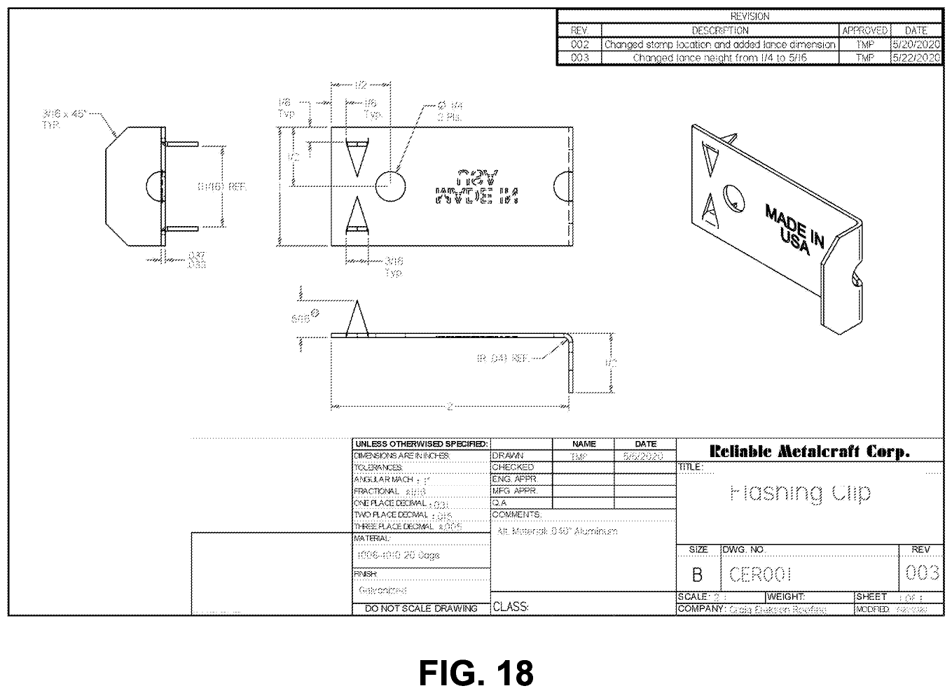

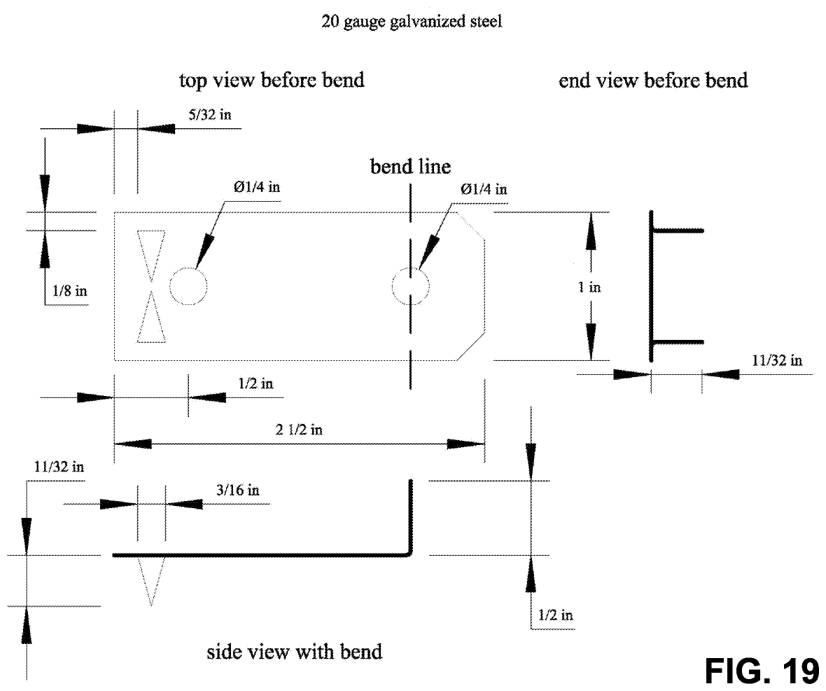

In some implementations, the covered opening fastener 100 comprises any suitable dimensions, such as the example dimensions shown in FIGS. 18 and 19.

In some implementations, the covered opening fastener 100 is composed of any suitable materials. For example, in some implementations, the covered opening fastener 100 may be composed of an aluminum, steel, or other metal material. In some implementations, the material may be galvanized or otherwise treated.

In some implementations, the covered opening fastener 100 can have any suitable appearance, such as the example appearances shown in the figures.

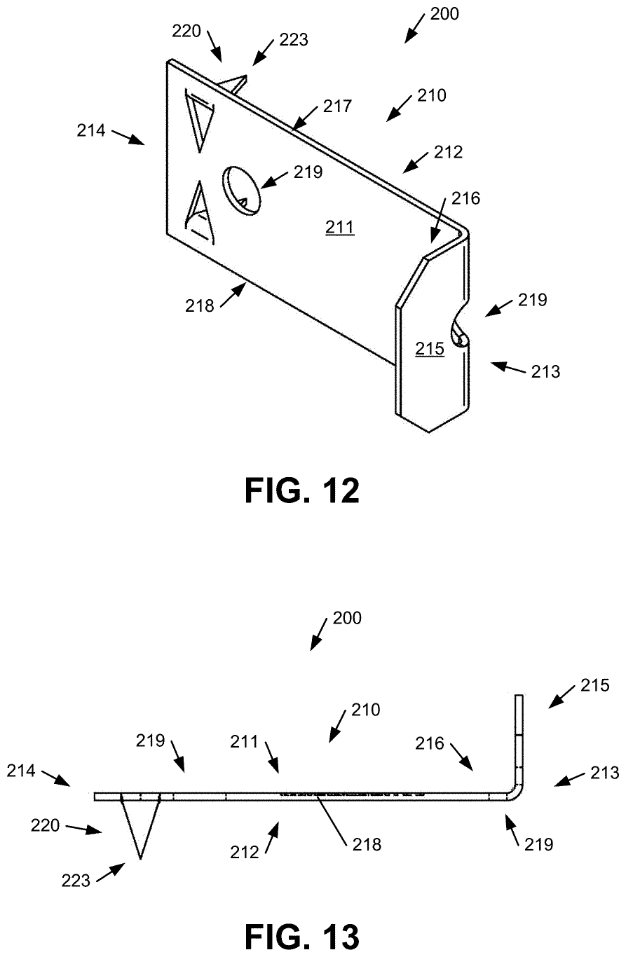

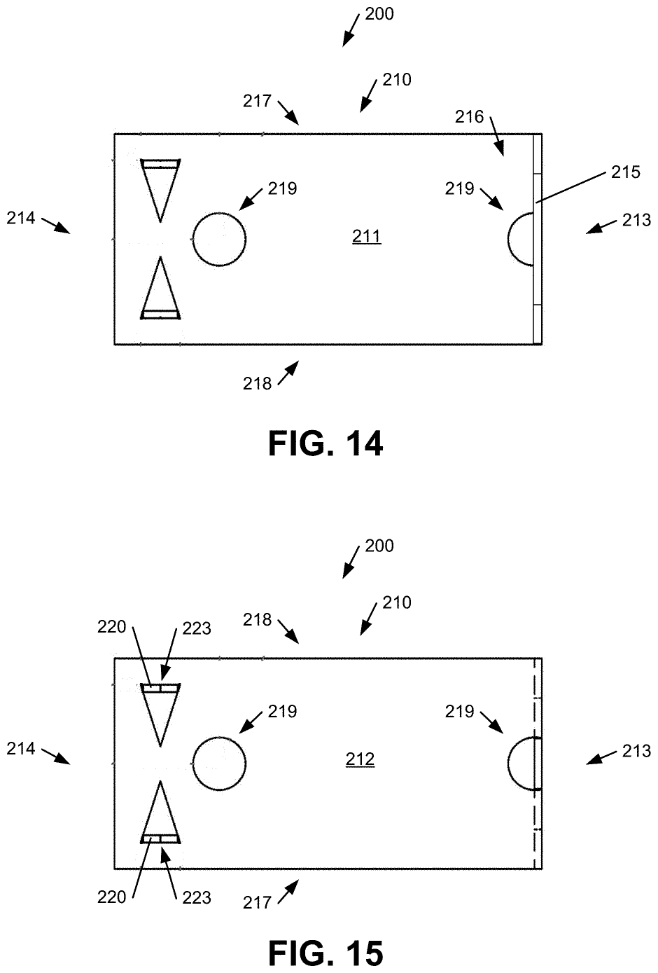

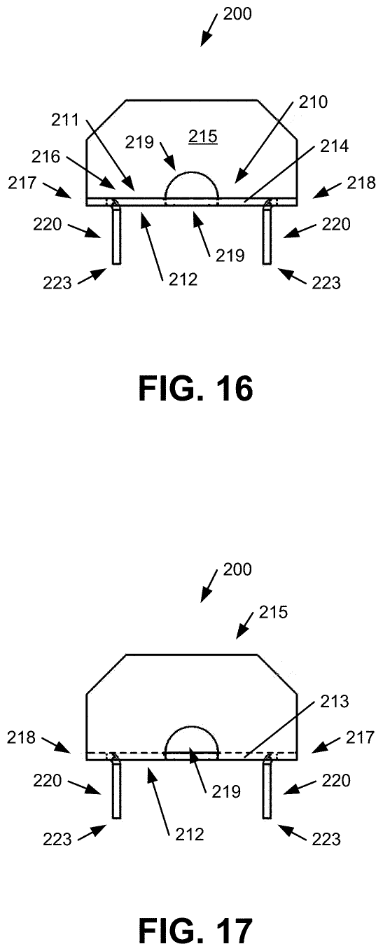

FIGS. 12-17 illustrate another implementation of an example covered opening fastener 200 according to the present disclosure. In some implementations, the covered opening fastener 200 is similar to the covered opening fastener 100, such as described above for FIG. 3 and FIGS. 8 and 9, which is indicated by like named and/or numbered components.

As shown in FIG. 12, in some implementations, the covered opening fastener 200 comprises a shelf 210 and one or more lances or spikes 220. In some implementations, the shelf 210 is similar to the above described shelf 110 (FIG. 3) of the covered opening fastener 100. In some implementations, the spikes 220 are similar to the above described shaft 120 (FIG. 3) and/or the cleat-like extensions (FIGS. 8 and 9) of the covered opening fastener 100.

In addition to the above described similar components of the shelf 110, in some implementations, as shown in FIG. 12, the shelf 210 may further comprise one or more openings 219. As shown in FIG. 12, in some implementations, at least one of the openings 219 is positioned adjacent to the spikes 220. For example, in some implementations, the opening 219 is positioned generally near and in between a first and second spike 220 that are positioned adjacent to the second side 214 of the covered opening fastener 200.

As shown in FIG. 12, in some implementations, the shelf 210 may further comprise another opening 219 positioned at or adjacent to the first side 213.

In some implementations, the one or more openings 219 may be generally circular. In some implementations, the one or more openings 219 may be any other suitable shape.

In some implementations, the one or more openings 219 extend through the shelf 210, including through the top surface 211 and the bottom surface 212.

In some implementations, the opening 219 positioned near the spikes 220 is configured to receive a nail 10 or other suitable fastener (such as shown in FIG. 11) therethrough. For example, in some implementations, the nail 10 or other suitable fastener may be received through the opening 219 to attach the covered opening fastener 200 in addition to the spikes 220, such as for additional support and/or reach or extension of such attachment.

In some implementations, the covered opening fastener 200 may further comprise a piece of adhesive tape. In some implementations, the adhesive tape may be attached to the bottom surface 212 or to any other suitable position of the covered opening fastener 200. For example, in some implementations, the adhesive tape may be attached to the bottom surface 212 adjacent to the spikes 220.

In some implementations, the covered opening fastener 200 may comprise the piece of adhesive tape and not comprise the spikes 220. For example, in some implementations, the adhesive tape may replace the attachment features provided by the spikes 220.

Alternately, in some implementations, the covered opening fastener 200 may comprise the adhesive tape and the spikes 220. For example, in some implementations, the adhesive tape may supplement the attachment features provided by the spikes 220.

In some implementations, the adhesive tape may be any suitable adhesive tape. For example, in some implementations, the adhesive tape may be a butyl tape. In some implementations, the adhesive tape may be double-sided (e.g., having adhesive on both surface sides of the tape).

In some implementations, the opening 219 positioned near the spikes 220 may be configured to provide any other suitable feature of the covered opening fastener 200.

In some implementations, the opening 219 positioned at or near the first side 213 may be configured to allow the hook portion 215 of the shelf 210 to be bent to form the channel 216 to receive and hold a roofing part 21 or other suitable component, such as described below. For example, in some implementations, the opening may allow the hook 215 to be bent more easily and/or without undesirably deforming the shelf 210 to receive and hold a roofing part 21 or other suitable component.

In some implementations, the opening 219 positioned at or near the first side 213 may be configured to provide any other suitable feature of the covered opening fastener 200.

As shown in FIG. 13, in some implementations, the spikes 220 extend from the bottom surface 212 of the shelf 210. In some implementations, the spikes 220 may extend from any other suitable part of the shelf 210.

In some implementations, the spikes 220 may be generally triangular shaped. For example, in some implementations, the spikes 220 may extend from the bottom surface 212 of the shelf 210 such that the apex or point 223 of the spikes 220 faces generally opposite from the bottom surface 212. In this way, in some implementations, the spikes 220 are configured to be driven (e.g., hammered) into a roofing part 21, 23 or other suitable component to attach the covered opening fastener 200, such as described below.

In some implementations, the spikes 220 may be any other suitable shape.

In some implementations, the spikes 220 are configured to be driven into and thereby attach the covered opening fastener 200 to a roofing part 23 or other suitable component, such as similar to the above described shaft 120 of the covered opening fastener 100.

FIGS. 18 and 19 illustrate additional views of the above described covered opening fastener 200 of FIGS. 12-17. FIGS. 18 and 19 include additional details about the covered opening fastener 100, 200, such as example dimensions and other features.

In some implementations, the covered opening fastener 200 may not comprise the spikes 220. For example, in some implementations, a nail 10 or other suitable fastener may be received through the opening 219 to attach the covered opening fastener 200 instead of the spikes 220. In some implementations, the above described piece of adhesive tape may attach the covered opening fastener 200 instead of the spikes 220.

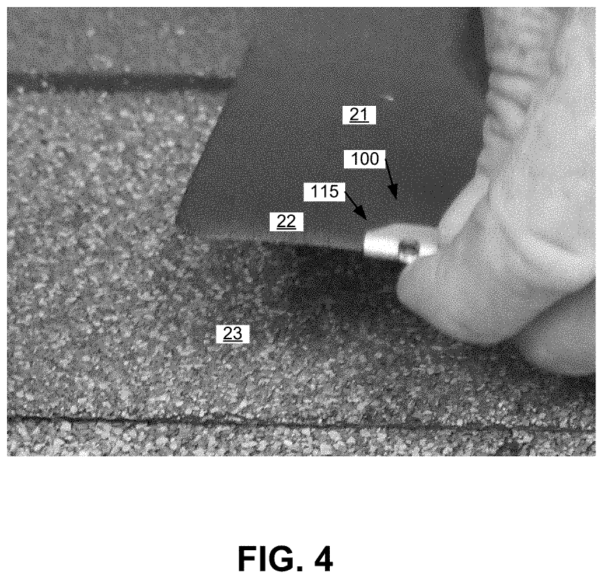

In some implementations, an example method of using the covered opening fastener 100, with respect to the above-described figures, comprises placing the covered opening fastener 100 on a first object such that the edge portion of the first object is received and held by the hook 115 of the covered opening fastener 100. For example, as shown in FIG. 4, in some implementations, the covered opening fastener 100 is placed on a first roofing part 21 such that the edge portion 22 of the first roofing part 21 is received and held by the hook 115 of the covered opening fastener 100. As shown in FIG. 6, in some implementations, the first object, such as the first roofing part 21, and the covered opening fastener 100 are thereby attached or otherwise secured together without forming an opening through the first object.

In some implementations, the method comprises driving the covered opening fastener 100 into and/or through a second object to thereby attach or otherwise secure the first object and the second object together by the covered opening fastener 100 without forming an opening through the first object. For example, as shown in FIG. 5, in some implementations, the shaft 120 of the covered opening fastener 100 is driven into and/or through the second roofing part 23. In some implementations, the covered opening fastener 100 may be driven through an edge portion of the second object.

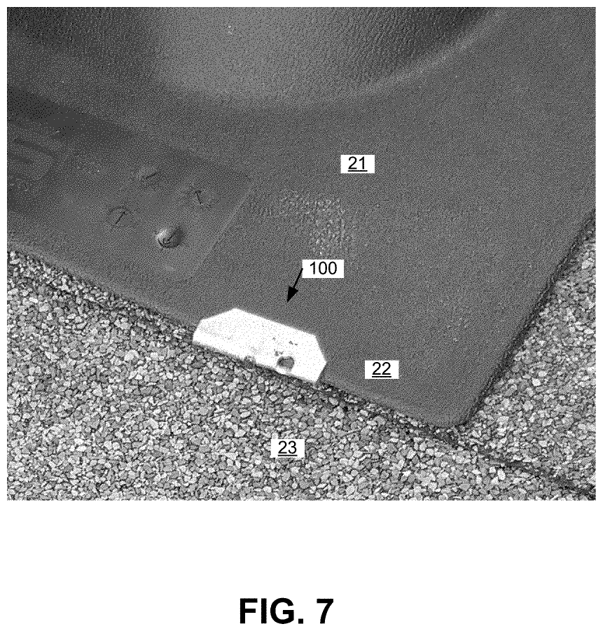

As shown in FIG. 7, in some implementations, the first roofing part 21 and the second roofing part 23 are thereby attached or otherwise secured together by the covered opening fastener 100 without forming an opening through the first roofing part 21.

In some implementations, the covered opening fastener 100 thereby further attaches or secures the first object and the second object together and to a third object. For example, in some implementations, the shaft 120 of the covered opening fastener 100 is also driven into and/or through a roof frame or other suitable structure to thereby attach or otherwise secure the first roofing part 21, the second roofing part 23, and the roof frame together by the covered opening fastener 100.

In some implementations, an example method of using the covered opening fastener 200, with respect to the above-described figures, comprises the same or similar steps as described above for the covered opening fastener 100, except that the shaft 120 is replaced by the spikes 220.

In some implementations, the method may further comprise bending the hook portion 215 of the shelf 210 to form the channel 216 and/or to receive and hold the roofing part 21 or other suitable component as described above. For example, in some implementations, the hook portion 215 may be bent using a hammer or any other suitable tool.

In some implementations, the method may further comprise driving a nail 10 or other suitable fastener (such as shown in FIG. 11) through the opening 219 of the shelf 210 adjacent to the spikes 220 and into the roofing part 23 or other suitable component. In this way, for example, in some implementations, the nail 10 or other suitable fastener attaches the covered opening fastener 200 in addition to the spikes 220, such as to provide additional support and/or reach or extension of the attachment.

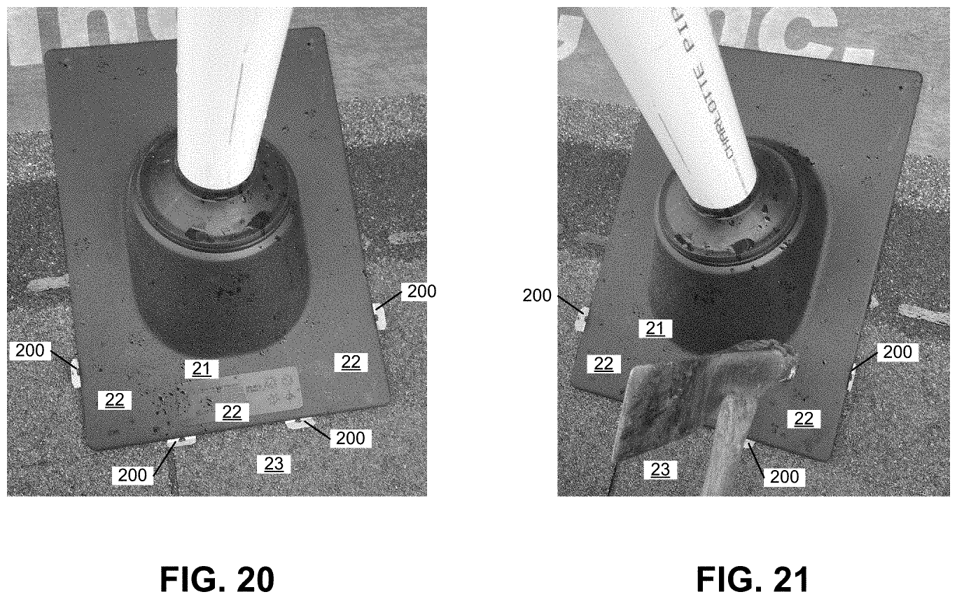

FIGS. 20-24 illustrate another example use of the covered opening fastener 200 according to the present disclosure. In some implementations, another example method of using the covered opening fastener 200, with respect to the above-described figures, comprises positioning the covered opening fastener 200 on a second object (such as a roof, roofing tile, or other roofing part) 23, such as shown in FIGS. 20-22.

As shown in FIG. 20, in some implementations, a first object (such as a roof flashing or other roofing part) 21 may be positioned adjacent to (e.g., on top of) the second roofing part 23 before or during the positioning of the covered opening fastener 200 on the second roofing part 23. For example, the first roofing part 21 may be used to determine the positioning of the covered opening fastener 200 so that the covered opening fastener 200 can be subsequently attached to the first roofing part 21, as described below.

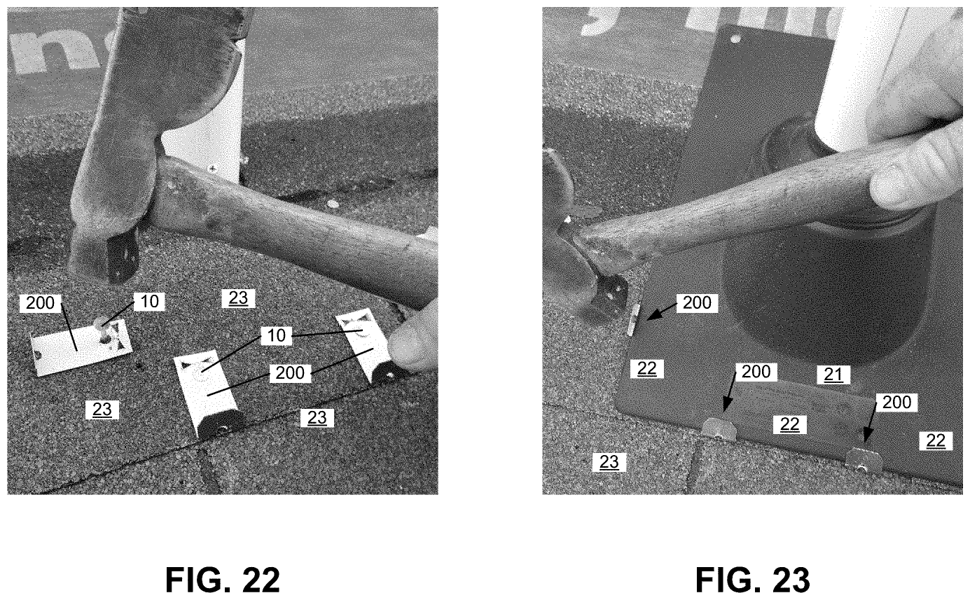

As shown in FIGS. 21 and 22, in some implementations, the method comprises attaching the covered opening fastener 200 to the second roofing part 23. For example, in some implementations, the spikes 220 of the covered opening fastener 200 are driven into and/or through the second roofing part 23.

As shown in FIG. 21, in some implementations, the spikes 220 are driven into the second roofing part 23 while the first roofing part 21 is positioned adjacent to the covered opening fastener 200. As shown in FIG. 22, in some implementations, the covered opening fastener 200 may be further (or alternately) secured to the second roofing part 23 by driving a nail 10 (or other suitable fastener) through the opening 219 into the second roofing part 23.

As shown in FIG. 23, in some implementations, the method comprises attaching the covered opening fastener 200 to the first roofing part 21. For example, in some implementations, the first roofing part 21 is positioned adjacent to the covered opening fastener 200. In some implementations, the hook portion 215 of the shelf 210 is bent (e.g., with a hammer or other suitable tool) to form the channel 216 and receive and hold the roofing part 21 therein, such as described more above.

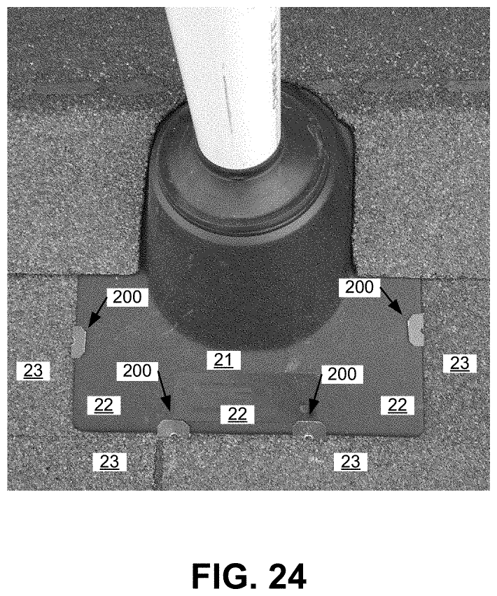

As shown in FIG. 24, the covered opening fastener 200 thereby attaches the first roofing part 21 and the second roofing part 23 together without forming an opening through the first roofing part 21 and by covering the opening(s) made by the covered opening fastener 200 in the second roofing part 23, such as described more above.

In some implementations, the covered opening fastener 100, 200 may be used as a roofing flashing clip, such as by the above described methods.

The figures, including photographs and drawings, comprised herewith may represent one or more implementations of the covered opening fastener.

Details shown in the figures, such as dimensions, descriptions, etc., are exemplary, and there may be implementations of other suitable details according to the present disclosure.

Reference throughout this specification to “an embodiment” or “implementation” or words of similar import means that a particular described feature, structure, or characteristic is comprised in at least one embodiment of the present invention. Thus, the phrase “in some implementations” or a phrase of similar import in various places throughout this specification does not necessarily refer to the same embodiment.

Many modifications and other embodiments of the inventions set forth herein will come to mind to one skilled in the art to which these inventions pertain having the benefit of the teachings presented in the foregoing descriptions and the associated drawings.

The described features, structures, or characteristics may be combined in any suitable manner in one or more embodiments. In the above description, numerous specific details are provided for a thorough understanding of embodiments of the invention. One skilled in the relevant art will recognize, however, that embodiments of the invention can be practiced without one or more of the specific details, or with other methods, components, materials, etc. In other instances, well-known structures, materials, or operations may not be shown or described in detail.

While operations may be depicted in the drawings in a particular order, this should not be understood as requiring that such operations be performed in the particular order shown or in sequential order, or that all illustrated operations be performed, to achieve desirable results.

1. A covered opening fastener comprising:
a shelf portion having a first surface extending lengthwise between a first side and a second side and extending widthwise between a third side and a fourth side, and having a second surface, opposite the first surface, extending lengthwise between the first side and the second side and extending widthwise between the third side and the fourth side;
a hook portion extending upward from the first side of the shelf portion and configured to fold over the first surface of the shelf portion toward the second side of the shelf portion to form a channel between the hook portion and the top surface of the shelf portion; and
a pointed portion extending from the second surface of the shelf portion adjacent to the second side of the shelf portion wherein the pointed portion is capable of being driven into an object when force is applied to the first surface above the pointed portion.

2. The covered opening fastener of claim 1 wherein the first surface and the second surface are rectangular.

3. The covered opening fastener of claim 1 wherein the channel is sized and shaped to receive a portion of a building roof flashing.

4. The covered opening fastener of claim 1 wherein the hook portion further extends above the first surface of the shelf portion toward the second side of the shelf portion thereby forming the channel between the hook portion and the top surface of the shelf portion.

5. The covered opening fastener of claim 4 wherein the channel is sized and shaped to receive a portion of a building roof flashing.

6. The covered opening fastener of claim 1 wherein the pointed portion is configured to penetrate into a building roof shingle and thereby attach the covered opening fastener to the building roof shingle.

7. The covered opening fastener of claim 1 wherein the pointed portion comprises at least one spike.

8. The covered opening fastener of claim 7 wherein the pointed portion comprises a first spike and a second spike.

9. The covered opening fastener of claim 1 wherein the pointed portion is cylindrical shaped.

10. The covered opening fastener of claim 1 wherein the pointed portion is triangular shaped.

11. The covered opening fastener of claim 1 further comprising an opening through the shelf portion, wherein the opening is sized and shaped to receive a nail fastener therethrough.

12. A method of using the covered opening fastener of claim 1 to attach a first object and a second object comprising:
penetrating the pointed portion into a first object thereby attaching the covered opening fastener to the first object;
placing a second object on the first surface of the covered opening fastener such that an edge of the second object is adjacent the hook portion; and
folding the hook portion over the second object and toward the second side of the shelf portion to form a channel between the hook portion and the top surface of the shelf portion with a portion of the second object received in the channel and thereby attaching the second object to the first object.

13. The method of claim 12 wherein the first object is a building roof shingle and the second object is a building roof flashing.

14. The method of claim 12 wherein penetrating the pointed portion into the first object comprises driving the pointed portion into the first object with a hammer.

15. The method of claim 12 wherein folding the hook portion further comprises securing the portion of the second object in the channel by forcing the hook portion down onto the portion of the second object.

16. A method of using the covered opening fastener of claim 1 to attach a first object and a second object comprising:
positioning a first object adjacent to a second object;
positioning the covered opening fastener between the first object and the second object such that the first object is positioned on the first surface of the covered opening fastener and an edge of the first object is positioned adjacent to the hook portion of the covered opening fastener;
penetrating the pointed portion into the second object thereby attaching the covered opening fastener to the second object;
folding the hook portion over the first object and toward the second side of the shelf portion to form a channel between the hook portion and the top surface of the shelf portion with a portion of the first object received in the channel and thereby attaching the first object to the second object.

17. The method of claim 16 further comprising driving a nail fastener through the covered opening fastener into the second object thereby further attaching the covered opening fastener to the second object.

18. The method of claim 16 wherein the first object is a building roof flashing and the second object is a building roof shingle.

19. The method of claim 16 wherein:
penetrating the pointed portion into the second object comprises driving the pointed portion into the second object; and
folding the hook portion further comprises securing the portion of the first object in the channel by forcing the hook portion down onto the portion of the first object.

20. A method of using the covered opening fastener of claim 4 to attach a first object and a second object comprising:
inserting an edge portion of a first object into the channel formed between the hook portion and the shelf portion; and
penetrating the pointed portion into a second object thereby attaching the covered opening fastener to the second object and thereby attaching the first object to the second object.
